(19) United States
(12) Patent Application Publication
(10) Pub. No.: US 2006/0169301 A1
(43) Pub. Date: Aug. 3, 2006

(54) Cleaning wipe with variable loft working surface

(76) Inventors: Thomas E. Haskett, Oakdale, MN (US); Amy M. Kunz, New Richmond, WI (US); Jill R. Munro, St. Paul, MN (US)

Correspondence Address: Attention: David B. Patchett, Esq.;Office of Intellectual Property Counsel, 3M Innovative Properties Company, P.O. Box 33427, St. Paul, MN, 55133-3427, US

(21) Appl. No.: 11/045,587

(22) Filed: Jan. 28, 2005

(51) Int. Cl. B08B 7/00

(52) U.S. Cl. 134/6; 15/228; 15/104.94

(57) ABSTRACT

A cleaning wipe useful as a wet cleaning wipe for picking up diverse debris, such as hair and other debris such as dirt, including a web defining a working surface opposite a second surface. The working surface has first, second, and third regions each having a different degree of loftiness and a different height. The degree of loftiness of the first region is greater than that of the second and third regions, and the degree of loftiness of the second region is greater than that of the third region. Finer debris, such as wetted hair, is captured and/or retained within the first region, whereas other debris such as particulates (e.g., dirt, sand) are captured and/or retained in the second region. In one embodiment, a plurality of the first, second, and third regions are defined on the working surface in a pattern.

### BACKGROUND

The present invention relates to cleaning wipes for removing debris from surfaces. More particularly, it relates to cleaning wipe constructions for removing diverse debris such as hair, dirt, dust, and the like, from hard surfaces, especially when wet.

Cleaning wiping products (or “wipes” or “sheets”) in various forms have long been used to clean debris from surfaces in residential and commercial environments. Virtually all available cleaning wipe products are generally similar in basic form, including a relatively thin base comprised of a fibrous material (or “web”) that is at least somewhat supple to enhance user handling. To this end, the number of different materials and manufacturing techniques have been developed (e.g., woven, non-woven, or knitted-based structures comprised of natural and/or synthetic fibers), each having certain characteristics adapted to at least partially satisfy a particular end use. In addition, efforts have been made to incorporate certain additives into the fiber web to better address the needs of specific applications.

One particularly problematic cleaning task faced by consumers is cleaning the bathroom or other rooms/surfaces in which hair (e.g., human hair) is abundantly present along with other difficult-to-remove debris such as scum, dirt, dried urine, hairspray, etc. In these environments, users are commonly required to perform several, distinct cleaning tasks on the same surface. For example, the user first employs a standard broom to sweep up hair and other loose debris. Subsequently, a sponge, wipe, or similar product is employed to scrub the bathroom floor (or other surfaces) to remove adhered debris (e.g., dirt or similar particulate debris that has become infused with water due to the high humidity associated with most bathrooms). Along these same lines, the user often desires to use a wetted wipe and/or saturated sponge to perform this task. When wet, the wipe and/or sponge more readily cleans the surface in question. Unfortunately, however, the preference for use of a wet cleaning product renders complete hair removal exceedingly difficult, necessitating that the sweeping task must first occur.

In particular, it has been found that with previously known wipe constructions, as the wipe is directed across a hard surface on which unwanted hair is accumulated, the hair will “collect” or agglomerate along the leading edge(s) (relative to a direction of wiping). As is commonly done, when the user changes wiping directions, the collected hair is not physically retained by the wipe, and thus is left behind. This phenomenon is even more prevalent when the wiping product carries a liquid or a liquid (e.g., water) is applied to the surface being cleaned; under these circumstances, the liquid causes the hair to mix or collect with dirt, making it even more likely that the conglomeration of hair/dirt will reside along the leading edge of the wiping product, releasing from the wiping product as soon as the wiping direction is changed. Frequent changes of direction commonly occur when cleaning bathrooms, particularly when cleaning around the toilet. Water also causes the hair to cling to the floor surface, making it difficult to remove or pick up.

Certain cleaning sheets have been suggested as being appropriate for cleaning hair. In particular, U.S. Patent Publication No. 2003/0049407 (“Disposable Cleaning Sheets Comprising a Plurality of Protrusions for Removing Debris from Surfaces”) purports to provide a disposable cleaning sheet having a plurality of protrusions, preferably polymeric hooks, extending from a working surface of the cleaning sheet for removing pet hair and human hair from soft surfaces, such as carpeting. Unfortunately, when wet and used across a hard surface, the described cleaning wipe will likely suffer from the same concerns identified above; namely, wetted hair will accumulate along a leading edge of the cleaning wipe (and thus not be retained by the hooks). Once a direction of wiping is changed, the agglomerated hair will be left behind. Further, the protruding hooks can produce an audible “scratching” noise when wiped across a hard surface, leading to a user concern that the surface is being damaged. Alternatively, wipes or other cleaning products having an adhesive applied to a surface thereof are known. Under dry conditions, the adhesive can readily assist in retaining hair. However, when exposed to water, the adhesiveness is typically greatly reduced or even lost, and thus serves no purpose. Similarly, wetted hair will not bond to the adhesive. Conversely, lofty, non-woven webs, could be useful for collecting hair from hard surfaces. However, this is essentially no better than using a broom in that the lofty material is unable to readily collect debris other than hair. Further, when wet, lofty non-woven materials are rendered essentially “flat” and simply push agglomerated hair in front of the wipe as it moves across the surface. As a result, a consumer is still required to perform two separate cleaning operations with two different cleaning implements.

Cleaning of a bathroom floor or other hard surface having hair, urine and other particulate debris currently requires a user to essentially clean the floor twice with at least two different cleaning products. Therefore, a need exists for a cleaning wipe and related method of manufacture that facilitates capture of hair and other particulate debris while wet.

### SUMMARY

One aspect of the present invention relates to a cleaning wipe useful as a wet cleaning wipe for picking up diverse debris, such as hair. In one embodiment, the cleaning wipe is useful in picking up wet hair, sand and dirt while also removing chemical debris such as urine and hairspray. The cleaning wipe includes a web defining a working surface opposite a second surface. The working surface has a first region, a second region, and a third region each having a different degree of loftiness and a different height. The degree of loftiness of the first region is greater than that of the second and third regions, and the degree of loftiness of the second region is greater than that of the third region. Similarly, the height of the first region is greater than that of the second and third regions, and the height of the second regions is greater than that of the third region. With this configuration, finer debris, such as hair or fine dust, is captured and/or retained within the first region, whereas other debris such as particulates (e.g., dirt, sand) are captured and/or retained in the second region. In one preferred embodiment, a plurality of the first, second, and third regions are defined on the working surface in a pattern. In another alternative embodiment, the cleaning wipe further includes one or more additional layers for retaining water and/or facilitating connection to a separate cleaning tool.

Another aspect of the present invention relates to a package of cleaning wipes for picking up debris, such as hair. The package includes a plurality of stacked cleaning wipes, a liquid, and a container. The plurality of stacked cleaning wipes each include a web defining a working surface having first, second, and third regions, with the first region having a higher degree of loftiness and height than the second and third regions, and the second region having a degree of loftiness and height greater than that of the third region. The liquid wets each of the stacked cleaning wipes. Finally, the container contains the wipes and the liquid. With this configuration, a user can readily select a pre-wetted cleaning wipe from the package for immediate use in cleaning a surface.

Yet another aspect of the present invention relates to a method of cleaning hair and other particulate debris from a surface. The method includes providing a wet cleaning wipe including a web defining a working surface having first, second, and third regions. The first region has a degree of loftiness and height greater than that of second and third regions, whereas the second region has a degree of loftiness and height greater than that of the third region. The wetted working surface of the wipe is guided across the surface to be cleaned such that hair and particulate debris are retained by the cleaning wipe. In particular, hair is primarily retained in the first region and the particulate debris is primarily retained in the second region. In one alternative embodiment, the cleaning wipe is secured to a tool, with the tool being manipulated to guide the working surface across the surface to be cleaned.

Yet another aspect of the present invention relates to a cleaning wipe useful as a wet wipe for picking up diverse debris, such as hair. The cleaning wipe includes a web defining a working surface opposite a second surface. The working surface has a uniform material construction and defines a plurality of laterally extending first regions, a plurality of laterally extending second regions, and a plurality of laterally extending third regions. The first, second, and third regions are arranged in a repeating pattern of adjacent first regions spaced by second regions adjacent ones of which are separated by one of the third regions. A width of each of the first regions is greater than a width of the third regions. Further, a degree of loftiness and height of the first region is greater than that of the second and third regions, and a degree of loftiness and height of the second region is greater than that of the third region.

### BRIEF DESCRIPTION OF THE DRAWINGS

FIG. 1 is a top, schematic illustration of one embodiment of a cleaning wipe in accordance with the present invention;

FIG. 2 is a schematical cross-sectional view of a portion of the cleaning wipe of FIG. 1, taken along the lines 2-2;

FIG. 3 is an enlarged, cross-sectional view of a portion of the cleaning wipe of FIG. 1, illustrating fibers within the wipe;

FIG. 4 is a schematic illustration of a system for forming the cleaning wipe of FIG. 1 in accordance with the present invention;

FIG. 5 is a schematical cross-sectional view of an alternative embodiment cleaning wipe in accordance with the present invention;

FIG. 6 is a perspective, exploded view of a cleaning tool useful with the cleaning wipe in accordance with the present invention;

FIG. 7 is a top view of an embossing roller pattern associated with manufacture of certain described examples; and

FIG. 8 is a top view of another embossing roller pattern associated with manufacture of certain other described examples.

### DETAILED DESCRIPTION

Cleaning Wipe Characteristics

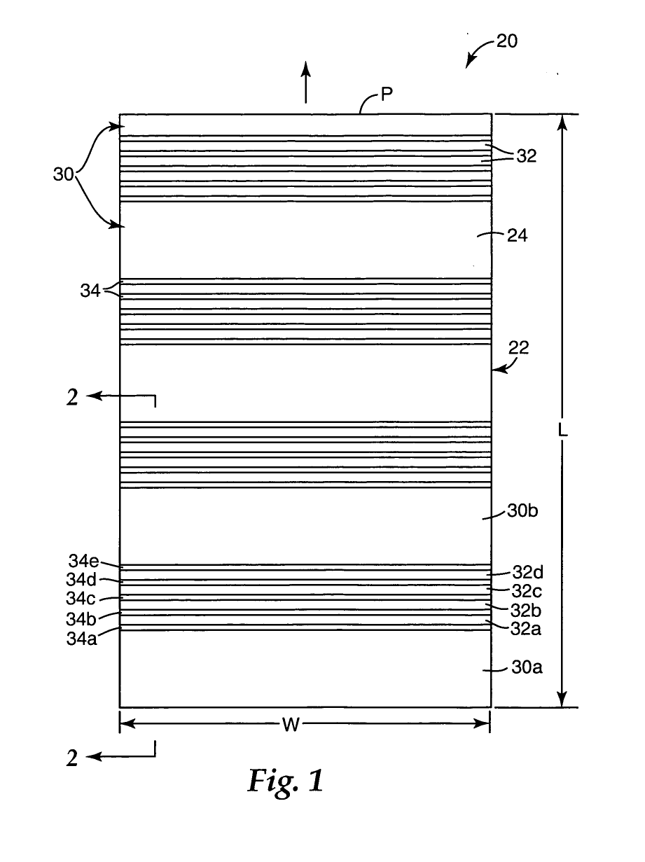

One embodiment of a cleaning wipe 20 in accordance with the present invention is provided in FIG. 1. In general terms, the cleaning wipe 20 includes a fiber web 22 forming a working surface 24. The term “working surface” is in reference to a side of the cleaning wipe 20 that is otherwise presented to and guided (or “wiped”) across a surface to be cleaned (not shown). In the view of FIG. 1, then, the working surface 24 is facing out of the page, with the cleaning wipe 20 having a second surface (hidden in FIG. 1) opposite the working surface 24. With this designation in mind, the working surface 24 defines one or more first regions 30, one or more second regions 32 and one or more third regions 34. As described below, the first, second and third regions 30-34 are characterized as having differing degrees of loftiness and height, adapted to facilitate capture or retention of lightweight, fine debris (not shown), for example hair (e.g., human hair, pet hair, etc.) in one or more of the first region(s) 30, and capture or retention of particulate-type debris (not shown), for example dirt in one or more of the second region(s) 32. In one embodiment, the cleaning wipe 20 is wet (e.g., water content of at least 25%), either as originally presented to a user (not shown) or by exposing the cleaning wipe 20 to water or other liquid during use. Thus, in one embodiment, the cleaning wipe 20 of the present invention is well-suited for use in cleaning hard surfaces in areas having both hair (wetted or dry) and other debris (e.g., wetted or dry sand, dust, urine, hairspray, etc.), such as a bathroom.

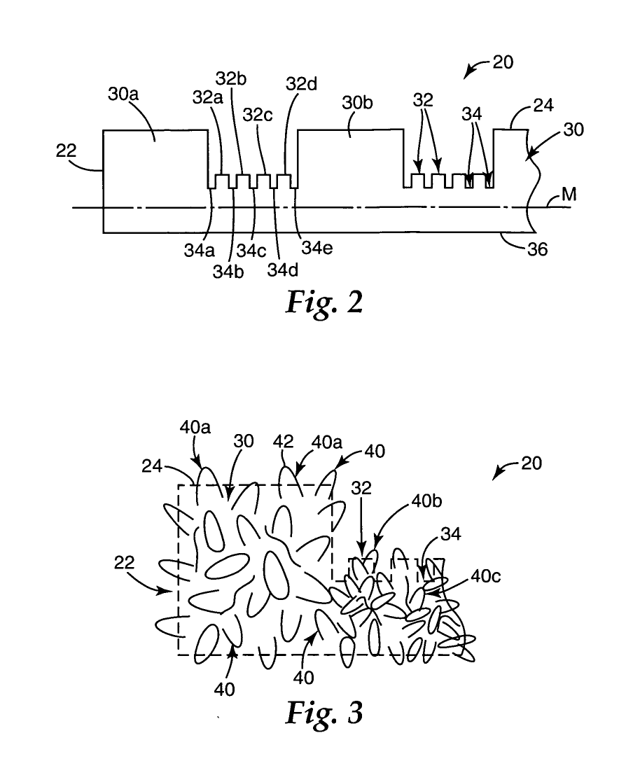

To better illustrate the loftiness characteristics associated with the first, second and third regions 30-34, reference is made to FIGS. 2 and 3. FIG. 2 is a schematic cross-sectional view of the cleaning wipe 20 (and further illustrates a second side 36 opposite the working surface 24), whereas FIG. 3 provides an enlarged view of one embodiment of the cleaning wipe 20 including fibers 40 (referenced generally). With this in mind, and in one embodiment, the web 22 has a uniform material construction (i.e., the web 22 is comprised of a singular material/composition as described below), and is processed to generate the differing first, second and third regions 30-34. In particular, the web 22 is configured such that the first regions 30 have a first degree of loftiness and a first height, the second regions 32 have a second degree of loftiness and a second height, and the third regions 34 have a third degree of loftiness and a third height. To this end, the regions 30-34 are visually distinct from one another, meaning that they are readily discernable to the naked eye. Alternatively, the web 22 can consist of two or more webs brought together to form the first regions 30 (and/or the second regions 32). For example, a first web can be provided that forms the second and third regions 32, 34, and second web(s) (higher loft) can be secured to the first web to form the first regions 30.

The term “degree of loftiness” as used in this specification is in reference to the spacing or “openness” of fibers otherwise forming the surface/area/volume in question. For example, a first surface/area/volume with fewer fibers per unit area or volume as compared to a second surface/area/volume comprised of the same denier fibers is considered to have a higher degree of loftiness. Alternatively, degree of loftiness can be defined as in terms of bulk density. “Bulk density” is the weight of a given web per unit volume. The web thickness can be measured in many ways; one accurate method employs an optical scanning technique.

The term “height” as used in this specification is in reference to extension of the working surface 24 beyond (or “above” relative to the orientations of FIGS. 2 and 3) relative to a mid-plane M that is otherwise generally parallel to a planar orientation of the web 22 (e.g., parallel to the second side 36 when the second side 36 is otherwise generally flat, it being understood that the second side 36 need not necessarily be flat). Alternatively, height can be measured from/relative to the second side 36.

With reference to the above conventions, the first degree of loftiness (i.e., the degree of loftiness associated with the first regions 30) is greater than the second degree of loftiness; and the second degree of loftiness is greater than the third degree of loftiness. Similarly, the first height (i.e., the height associated with the first regions 30) is greater than the second height; and the second height is greater than the third height. With specific reference to FIG. 3, the degree of loftiness is better illustrated by the “openness” of the fibers 40. For example, the first regions 30 can be described as including fibers 40a, the second regions 32 as including the fibers 40b, and the third regions 34 as including the fibers 40c. The fibers 40a are more distinctly spaced apart as compared to the fibers 40b; and the fibers 40b are more distinctly spaced apart as compared to the fibers 40c. Thus, the first regions 30 can be described as having fewer fibers 40 per unit volume as compared to the number of fibers 40 per unit volume of the second regions 32. Similarly, the second regions 32 can be described as having fewer fibers 40 per unit volume as compared to the number of fibers 40 per unit volume of the third regions 34. As described below, in one embodiment, this difference in degree of loftiness or fibers per unit volume can be achieved by compressing the web 22 to a greater extent in the third regions 34 as compared to the second regions 32, and by compressing the web 22 to a greater extent in the second regions 32 as compared to the first regions 30.

Regardless, in one embodiment, the bulk density of the first regions 30 is at least 100% less than the bulk density of the second regions 32, more preferably at least 200% less than, and even more preferably at least 300% less than. It will be understood that by having a lesser bulk density, the first degree of loftiness (of the first regions 30) is thus greater than the second degree of loftiness (of the second regions 32) as bulk density has an inverse relationship with loftiness. In a further embodiment, the bulk density of the second regions 32 is at least 100% less than the bulk density of the third regions 34, and more preferably at least 200% less than.

As further evidenced by FIG. 3, the fibers 40 comprising the web 22 are, in one embodiment, randomly or semi-randomly dispersed within the web 22. Thus, the web 22 does not have clear “edges” as otherwise reflected in the schematic illustrations of FIGS. 1 and 2. Instead, various ones of the fibers 40 “extend” or project beyond hypothetical edges of the web 22 (shown with dashed lines in FIG. 3). With this construction, the “height” of a particular region can be more accurately described as the nominal height defined by a majority of the fibers 40 positioned/extending at the working surface 24. For example, the fibers 40a combine to define a height of the first region 30 shown in FIG. 3. It will be further understood, then, that individual ones of the first regions 30 need not have identical heights, nor need the second regions 32 and/or the third regions 34.

Regardless, and in one embodiment, the height of the first regions 30 is at least 120% of the height of the second regions 32, more preferably at least 150%, and even more preferably at least 200%. In a further embodiment, the height of the second regions 32 is at least 110% of the height of the third regions 34, more preferably at least 125%, and even more preferably at least 135%. Alternatively stated, relative to a general plane of the working surface 24 defined by the third regions 34, the second regions 32 extend beyond (or “above” relative to the orientation of FIGS. 2 and 3) the third regions 34, and the first regions 30 extend beyond (or “above” relative to the orientation of FIGS. 2 and 3) the second regions 32.

Returning to FIGS. 1 and 2, the first, second and third regions 30-34 are arranged, in one embodiment, to define a pattern. For example, in one embodiment, the first regions 30 can be defined as including a series of pairs of adjacent first regions, such as the first regions 30a and 30b. The adjacent first regions 30a, 30b are spaced from one another by a plurality of the second regions 32 (designated in FIGS. 1 and 2 as the second regions 32a, 32b, 32c, and 32d) and a plurality of the third regions 34 (designated in FIGS. 1 and 2 as the third regions 34a, 34b, 34c, 34d, and 34e). Further, the plurality of second regions 32a-32d located between the adjacent first regions 30a, 30b are each separated by a respective one of the third regions 34b-34d. For example, the second regions 32a, 32b are separated by the third region 34b. In one embodiment, this pattern is repeated across an entirety of the working surface 24 (e.g., the same number of second regions 32 and third regions 34 are disposed between adjacent pairs of the first regions 30, with the first regions 30 each having the same dimensions, the second regions 32 each having the same dimensions, and the third regions 34 each having the same dimensions). Alternatively, the pattern can be non-repeating. Regardless, at least one adjacent pair of first regions 30 are formed and separated by at least one of the second regions 32 and at least one of the third regions 34.

In one embodiment, to promote the capture or retention of fine, lightweight debris (e.g., hair) in the first regions 30, the first regions 30 are wider than the second and third regions 32, 34. To this end, each of the regions 30-34 can be described as generally defining a length and a width (it being recalled that in accordance with one embodiment in which the web 22 includes the randomly distributed fibers 40, distinct edges (and thus uniform width) are not necessarily present). Relative to a perimeter P of the web 22, the regions 30-34 are oriented such that the length of each region 30-34 extends across at least a majority, more preferably at least 75%, and in one embodiment an entirety, of a dimension of the perimeter P. For example, with the embodiment of FIG. 1 in which the web 22 has the perimeter P that otherwise is generally rectangular, having a length L and a width W, each of the regions 30-34 extends across the width W. In other words, the length of each of the regions 30-34 approximates the width W of the web 22. Alternatively, and as described below, the web 22, and thus the cleaning wipe 20, can assume a wide variety of other shapes such that the perimeter P need not be rectangular. Regardless, the regions 30-34 are preferably arranged such that the respective lengths extend generally perpendicular to an intended wiping direction (shown with an arrow in FIG. 1).

With the above conventions in mind, a width of each of the first regions 30 is, in one embodiment, wider that a width of the second regions 32 and the third regions 34. For example, in one embodiment, a width of the first regions 30 is at least 150% of a width of the second and third regions 32, 34; more preferably at least 225%; and even more preferably at least 300%. Additionally, in one embodiment, a width of the second regions 32 is wider than the third regions 34, for example on the order of 200%-300% wider. Alternatively, the second regions 32 can be even wider or less wide as compared to the third regions 34. Further, and in one embodiment, a significant spacing is provided between adjacent pairs of the first regions 30 (e.g., the first regions 30a, 30b) via the one or more second regions 32 (e.g., the second regions 32a-32d) and the one or more third regions 34 (e.g., the third regions 34a-34e). For example, in one embodiment, a spacing between adjacent pairs of the first regions 30 (e.g., the first regions 30a, 30b) is not less than 75% of the width of the first regions 30; more preferably at least 100% of the width of the first regions 30; even more preferably at least 150% of the width of the first regions 30.

Although the first regions 30, the second regions 32, and the third regions 34, respectively, are illustrated in FIG. 1 as being identical in terms of shape and size, individual ones of the regions 30, 32 and/or 34 can vary from one another. For example, in one alternative embodiment, a first one of the first regions 30 can be wider that a second one of the first regions 30. Similarly, ones of the second regions 32 can vary in width from others of the second regions 32, as can the third regions 34. Further, one or more of the regions 30, 32, and/or 34 need not have the generally rectangular shape depicted in the exemplary embodiment of FIG. 1. For example, one or more or all of the first regions 30 can be triangular, circular or wavy, as can one or more or all of the second regions 32 and/or the third regions 34. The present invention encompasses virtually any configuration of the regions 30, 32 and 34 so long as at least one of each of the first, second and third regions 30-34 are provided, with the first region 30 having a higher degree of loftiness and height as compared to the second and third regions 32, 34, and the second region 32 having a higher degree of loftiness and height as compared to the third region 34. Regardless, in one embodiment, it has surprisingly been found that where the cleaning wipe 20 is adapted for attachment to a cleaning tool head (described below) otherwise providing a major dimension on the order of 5 inches (plus or minus 1 inch), a minimum of two of the first regions 30 is included with the cleaning wipe 20 to provide uniform weight support. Under these same end-use conditions, it has further been surprisingly found that providing more than five of the first regions 30 negatively affects performance.

Web Constructions

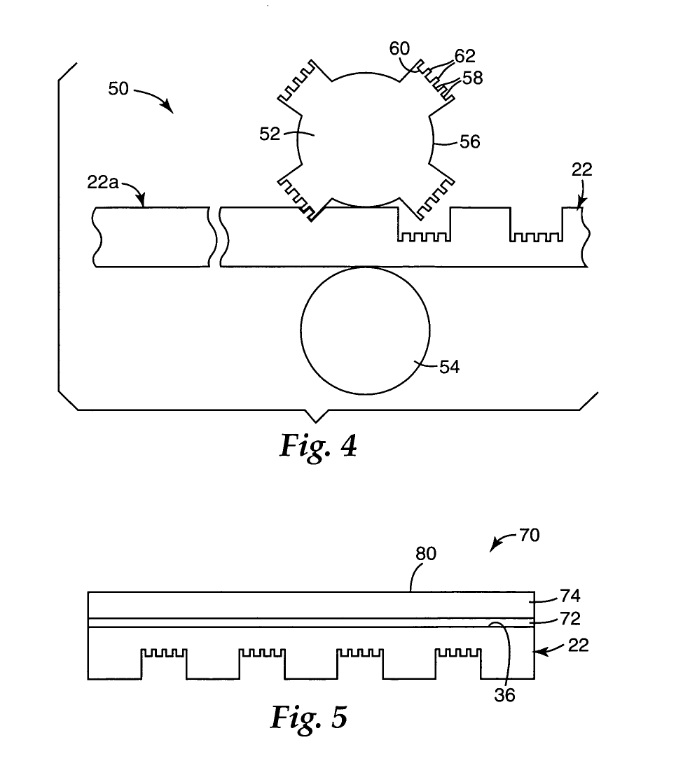

The web 22 can assume a wide variety of constructions that facilitate formation of the high loft first regions 30. As described below, in one embodiment, the working surface 24 is defined by subjecting an initial web or combination of two or more webs (that otherwise result in the web 22) to various processing methods, for example compression. With this in mind, the following description of the web 22 is with respect to an initial web 22a (shown in FIG. 4) following initial formation and prior to subsequent processing to otherwise form the working surface 24.

The web 22a or individual fiber web layers thereof can be a knitted, woven, or preferably a non-woven fibrous material. With the one embodiment in which the web 22a is a non-woven fibrous structure, the web 22a is comprised of individual fibers entangled with one another (and optionally bonded) in a desired fashion. The fibers are preferably synthetic or manufactured, but may include natural fibers. As used herein, the term “fiber” includes fibers of indefinite length (e.g., filaments) and fibers of discrete length (e.g., staple fibers). The fibers used in connection with the web 22a may be multicomponent fibers. The term “multicomponent fiber” refers to a fiber having at least two distinct longitudinally coextensive structured polymer domains in the fiber cross-section as opposed to blends where the domains tend to be dispersed, random, or unstructured. Regardless, useful fiberous materials include, for example, polyesters, polyamides, polyimides, nylon, polyolefins (e.g., polypropylene and polyethylene), etc., of any appropriate fiber length and denier, and mixtures thereof. Further, some or all of the fibers can have special treatments to enhance the hydrophilic properties, such as additives including super-absorbing gel polymers; also, powder(s) or fiber(s) can be added to enhance liquid holding capacity.

Small denier size staple fibers (e.g., 3d-15d) provide the web 22a with smaller pore sizes and more surface area as compared to a fiber web made with larger denier fibers (e.g., 20d-200d) that otherwise provides the web 22a with larger pore sizes and less surface area. The small denier fiber webs are best suited for cleaning surfaces contaminated with fine dust and dirt particles, whereas the large denier fiber webs are best suited for cleaning surfaces contaminated with larger dirt particles such as sand, food crumbs, lawn debris, etc. As described above, the larger pore sizes of the larger denier staple fibers allows the larger contaminant particles to enter, and be retained by, the matrix of the fiber web. The web 22a of the present invention can include one or both of the small and/or large denier fibers that may or may not be staple fibers. In one embodiment, the fiber web 22a includes crimped, high heat distortion fibers. Preferably, however, to ensure desired loftiness, a majority of the fibers of the web 22a are of a larger denier (e.g., at least 20 denier, more preferably at least 25 denier). For example, in one embodiment, the web 22 includes 55% 32 denier PET fibers, 15% 1.5 denier Rayon fibers, and 30% 2 denier bi-component melty fibers. A minimum web weight of 30 gsm has surprisingly been found necessary, in one embodiment, to adequately fill out the web geometry during a subsequent embossing process (described below). Further, the web 22a preferably contains a hydrophilic fiber content such as rayon, cellulose, viscose, and/or hydrophilic treated fiber(s), so that liquid can be transferred by gravity and/or in response to a force placed on the resultant cleaning wipe 20 for wetting a surface being cleaned.

Regardless of the exact fiber composition, in one embodiment, the fibers 40 are preferably randomly oriented, and bonded by compression and polymeric bonding of the fibers (e.g., bi-component fibers) at the edges to define partial or complete loops and to bond the formed web 22a to a backing (not shown). Alternatively, spunbond or adhesive webs or spray adhesives, or any other known technique can also be used to bond the formed web 22a to a backing.

As shown in FIG. 3, for example, some or a majority or all of the loop-like fibers 40 are oriented such that a closed end 42 (referenced in FIG. 3 for several of the fibers 40) is at an outer face of the working surface 24. This configuration of the fibers 40 is in contrast to other wipe constructions in which the working face has hooks. It has surprisingly been found that by forming the fibers 40 as loops, the resultant cleaning wipe 20 does not generate an audible “scratching” noise as the working surface 24 is wiped across a hard surface, yet desired capture/retention of debris is still achieved. When polymer hooks are used to pick up hair, consumers have expressed concerns that if a scratching noise is produced, the surface being cleaned has been damaged. The one embodiment of the present invention in which the fibers 40 otherwise defining the working surface 24 are loop-like overcomes this concern. Alternatively, the fibers 40 can have a wide variety of other configurations, and need not be loops or loop-like.

With the above properties in mind, the initial web 22a can be formed in a variety of known fashions including, for example, carding, spunbond, meltblown, airlaid, wetlaid, etc. The initial web 22a can be consolidated by any known technique such as, for example, hydroentanglement, thermal bonding (e.g., calender or through air), chemical bonding, etc.

Method of Processing the Web

Once the initial web 22a is formed, the web 22a is subjected to processing to produce the working surface 24 consisting of one or more of the first region(s) 30, one or more of the second region(s) 32, and one or more of the third region(s) 34. In one embodiment, the working surface 24 is formed by subjecting the initial web 22a to compressive forces, for example by passing the initial web 22a between a patterned embossing roller and a flat roller (or an engraved roller). FIG. 4 illustrates one embodiment of a calender system 50 capable of processing the initial web 22a to form the working surface 24. The system 50 includes a patterned embossing roller 52 and a flat roller 54. The embossing roller 52 defines a pattern of grooves and lands, including first grooves 56 and second grooves 58 as well as first lands 60 and second lands 62 (with the first lands 60 being defined at the base of the second grooves 58 and the second lands 62 defining a maximum outer diameter of the roller 52). As described below, the first grooves 56 are deeper than the second grooves 58, and correspond with/generate the first regions 30, whereas the second grooves 58 correspond with/generate the second regions 32. In other words, the first lands 60 correspond with/generate the second regions 32, and the second lands 62 correspond with/generate the third regions 34.

The initial web 22a is passed between the embossing roller 52 and the flat roller 54. A constant distance between center points of the rollers 52, 54 is maintained, whereby a minimum distance between the rollers 52, 54 is achieved at the second lands 62. The rollers 52, 54 impart a compression force on to the initial web 22a, with maximum compression being achieved at the second lands 62, intermediate compression being achieved at the first lands 60, and minimal or no compression occurring at the first grooves 56. The resultant web 22 is thus characterized by the third regions 34 being more compressed than the second regions 32, and the second regions 32 being more compressed than the first regions 30. While the second side 36 is shown as being relative flat following processing by the system 50, the system 50 can alternatively be configured to render the second side 36 to have desired, non-continuous shape(s).

A number of other manufacturing techniques can be employed to process the initial web 22a in a manner that generates the desired working surface 24. For example, the patterned embossing roller 52 can incorporate different patterns from that shown. In another embodiment, a heavy weight carded web (e.g., 150 gsm) can be embossed as described above with reference to FIG. 4, with the resultant web serving as both a working layer and a backing absorbent layer (akin to the embodiment of FIG. 5 described below). Alternatively, the web 22 can be formed as a multi-component web (e.g., as a substrate) in which high loft material is attached to a base web to generate the first regions 30 and/or the second regions 32.

Additional Cleaning Wave Components

While the cleaning wipe 20 has been described as including the single web 22, in one preferred embodiment, additional webs/substrates are provided. For example, FIG. 5 illustrates one preferred alternative embodiment cleaning wipe 70 including the web 22, an intermediate layer 72 and an outer layer 74. The intermediate layer 72 is attached to the second side 36 of the web 22, whereas the outer layer 74 is attached to the intermediate layer 72 opposite the web 22. As described below, the intermediate layer 72 and the outer layer 74 provide additional, beneficial features to the cleaning wipe 70.

In one embodiment, the intermediate layer 72 is configured to readily absorb/retain water. For example, the intermediate layer 72 is comprised of a cellulose material, although any other similar material is equally acceptable such as fiber blends of rayon, cellulose, viscose, or hydrophilic fibers. With this one configuration, then, the intermediate layer 72 retains water that can otherwise assist in performing a surface cleaning operation.

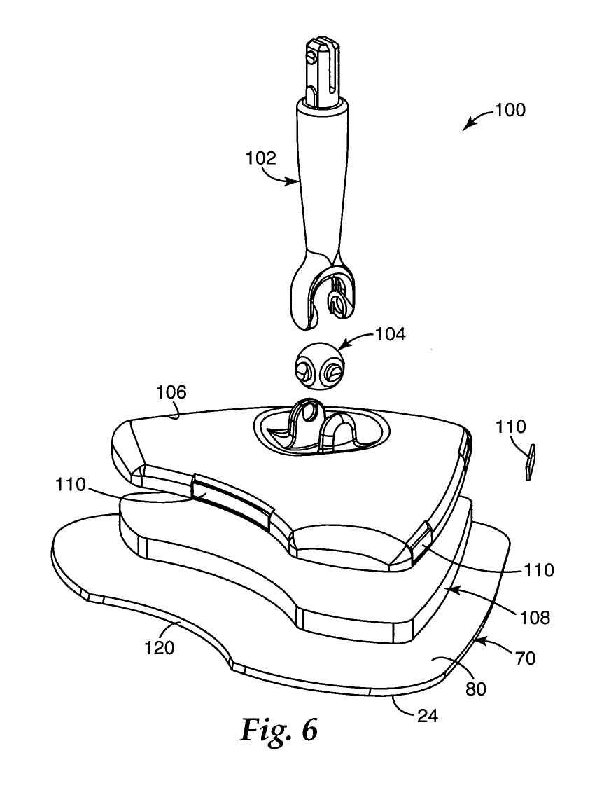

In one embodiment, the outer layer 74 is configured to facilitate attachment/mounting of the cleaning wipe 70 to a cleaning implement or tool (not shown in FIG. 6, but described below). For example, the outer layer 74 can include or consist of a plurality of loops (e.g., loop or loop-like fibers) or similar structures (e.g., hooks) extending from a back surface 80 of the cleaning wipe 70. Alternatively, the outer layer 74 can include or have attached thereto any other form of fastening component, such as mechanical fasteners, auto-adhesion polymers, polar polymers, etc. The fastening component(s) can be provided across an entirety of the back surface 80, or can be discretely located (e.g., pattern coated adhesive). Conversely, the tool can be adapted to retain the cleaning wipe 70 without the provision of an attachment/mounting component with the cleaning wipe 70 (e.g., the tool can include mechanical grippers for retaining the cleaning wipe 10).

Method of Use and Packaging

With reference to FIG. 6, in one embodiment, the cleaning wipe 70 is used in conjunction with an appropriate cleaning implement or tool, a portion of which is shown at 100. The tool 100 includes, in one embodiment, a neck 102, a joint 104, a head 106, and a support pad 108. In general terms, the neck 102 is attached to the head 106 via the joint 104. Further, though not shown, the neck 102 can form or be assembled to a separate handle. The support pad 108 is secured to the head 106 via an appropriate mounting mechanism (e.g., mechanical fastener, adhesive, etc.). Alternatively, the tool 100 can assume a plethora of different configurations and need not, for example, include the joint 104 and/or the support pad 108. Regardless, the head 106 includes attachment devices 110 (one of which is shown apart from the head 106 in FIG. 6) that otherwise interface with the cleaning wipe 70 as described below. In one embodiment, the attachment devices are micro-hooks, adapted to interface with the loops provided with the cleaning wipe 70, as previously described.

As illustrated in FIG. 6, the cleaning wipe 70 has an overall shape and size commensurate with the head 106. For example, with the one embodiment of FIG. 6 in which the head 106 is generally triangular in shape, the cleaning wipe 70 also assumes a generally triangular shape. Preferably, however, the cleaning wipe 70 has a larger size or surface area as compared to the head 106. With this one embodiment, then, the cleaning wipe 70 is assembled to the head 106 (and thus the support pad 108) by wrapping edges of the cleaning wipe 70 around a perimeter of the head 106 such that the back surface 80 contacts the attachment devices 110. In particular, and in one embodiment, the previously-mentioned loops provided with the cleaning wipe 70 connect with the hooks (not specifically illustrated in FIG. 6) of the attachment devices 110, thus securing the cleaning wipe 70 to the head 106. In one embodiment, the cleaning wipe 70 further includes a tab (not shown) extending from a side 120 thereof that otherwise facilitates a user removing the cleaning wipe 70 from the head 106 following use. Alternatively, the cleaning wipe 70 can be mounted to and removed from the tool 100 in a wide variety of other fashions.

Once mounted to the tool 100, the tool 100 is manipulated to guide the working surface 24 (FIG. 6) of the cleaning wipe 70 across a surface to be cleaned (not shown) as part of a cleaning operation (such as cleaning a bathroom floor). In this regard, the cleaning wipe 70 is preferably wetted prior to and/or during the cleaning operation. The user (not shown) can immerse the cleaning wipe in water or similar liquid following assembly to the tool 100 and just prior to performing the cleaning operation. Alternatively, the cleaning wipe 70 can be provided to the user in a wetted state. For example, in one embodiment, a package (not shown) of cleaning wipes 70 is provided to the user, consisting of a container containing a stack of the cleaning wipes 70 (e.g., 10, 25, 50, etc.) and a volume of a water-based solution (e.g., 99.5% water and a surfactant and a fragrance). With this configuration, the cleaning wipes 70 are in a pre-wetted state when provided to the user who simply removes one of the cleaning wipes 70 from the container and mounts it to the tool 100. In another alternative embodiment, the cleaning wipe 70, in either pre-wetted or dry form, are handled directly by the user's hand, such that a separate cleaning tool or implement is not required.

Regardless of how the cleaning wipe 20, 70 is deployed, the wipe 20, 70 is uniquely able to capture and retain different types of debris. In particular, and with reference to FIG. 2, even when the cleaning wipe 20, 70 is wet, lightweight, fine debris, and specifically including human or pet hair, is captured within and retained by the first regions 30 due to their high loft in combination with the above-described spacing between adjacent pairs of the first regions 30. Conversely, dirt and other particulate-type debris, as well as more adherent debris such as films or scum, is readily captured and retained within the second regions 32 due to their loft in combination with the spacing provided by the third regions 34.

### EXAMPLES

The following examples and comparative examples further describe the cleaning wipes of the present invention, methods of forming the cleaning wipes, and the tests performed to determine various performance characteristics. The examples are provided for exemplary purposes to facilitate an understanding of the invention, and should not be construed to limit the invention to the examples.

### Example 1

A lofty 100 gsm web comprised of a blend of 55% 25 denier T-295 PET fiber from KoSa, Charlotte, N.C., 15% 1.5 denier 8648 Rayon fiber from Lenzing, and 30% T-254 bi-component fiber from KoSa was blended and carded into a uniform web of loose fibers using a Hergeth carding machine. The carded web was then processed though an oven to melt the sheath of the bi-component fiber to bond the web together for future processing. Alternately, the carded web could be fed directly to the embossing rollers (described below), thus bypassing the oven process. The bonded web was then processed through a calender system including a patterned corrugated roller and a flat roller. In particular, the corrugated roller had seven corrugations per lineal inch in the machine direction. Both rollers were heated to about 295° F. to provide energy for forming and bonding. Also, pressure of 100 PLI was provided to the closed rollers. The 100 gsm blended web was fed into the embossing roll where it was compressed and bonded to the final machine direction corrugated geometry, resulting in a working surface having a plurality of first and second regions of differing density (or loftiness). The formed web was glued to a 3.5 oz/yd² absorbent layer from Sage Products, Inc. (CS120-0825), and loaded with 600% by weight cleaning solution.

### Example 2

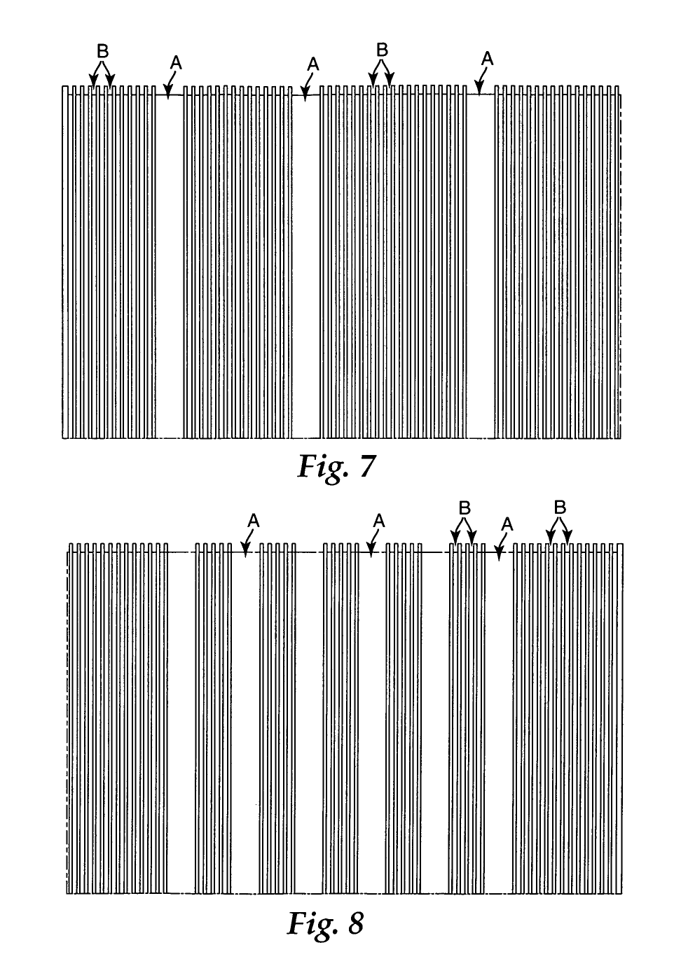

A lofty 100 gsm web comprised of a blend of 55% 25 denier T-295 PET fiber from KoSa, Charlotte, N.C., 15% 1.5 denier 8648 Rayon fiber from Lenzing, and 30% T-254 bi-component fiber from KoSa was blended and carded into a uniform web of loose fibers using a Hergeth carding machine. The carded web was then processed though an oven to melt the sheath of the bi-component fiber to bond the web together for future processing. Alternately, the carded web could be fed directly to the embossing rollers (described below), thus bypassing the oven process. The bonded web was then processed through a calender system including a patterned embossing roller and a flat roller. With Example 2, the patterned embossing roller was a three level embossing roller, the pattern of which is shown in FIG. 7, with the pattern being applied to the web in the machine direction. Both rollers were heated to about 295° F. to provide energy for forming and bonding. Also, pressure of 100 PLI was provided to the closed rollers. The 100 gsm blended web was fed into the embossing rollers where it was compressed and bonded to the final machine direction, three level geometry. More particularly, the embossing roller pattern (FIG. 7) included segments (A) of increased lateral spacing between adjacent lands, and segments (B) of decreased lateral spacing between adjacent lands (as compared to the segments A). When processed through this roller configuration, the working surface of the resultant web had regions of high loft (akin to the first regions 30 of FIGS. 1-3) corresponding with the segments A, and regions of intermediate loft (akin to the second regions 32 of FIGS. 1-3) corresponding with the segments B. Direct contact with the lands resulted in regions of lower loft (akin to the third regions 34 of FIGS. 1-3). The formed web was glued to a 3.5 oz/yd² absorbent layer from Sage Products Inc. (CS120-0825), and loaded with 600% by weight cleaning solution.

### Example 3

A lofty 100 gsm web comprised of a blend of 55% 25 denier T-295 PET fiber from KoSa, Charlotte, N.C., 15% 1.5 denier 8648 Rayon fiber from Lenzing, and 30% T-254 bi-component fiber from KoSa was blended and carded into a uniform web of loose fibers using a Hergeth carding machine. The carded web was then processed though an oven to melt the sheath of the bi-component fiber to bond the web together for future processing. Alternately, the carded web could be fed directly to the embossing rollers (described below), thus bypassing the oven process. The bonded web was then processed through a calender system including a patterned embossing roller and a flat roller. With Example 3, the patterned embossing roller was a three level embossing roller, the pattern of which is shown in FIG. 8, with the pattern being applied to the web in the machine direction. Both rollers were heated to about 295° F. to provide energy for forming and bonding. Also, pressure of 100 PLI was provided to the closed rollers. The 100 gsm blended web was fed into the embossing rollers where it was compressed and bonded to the final machine direction, three level geometry. More particularly, the embossing roller pattern (FIG. 8) included segments (A) of increased lateral spacing between adjacent lands, and segments (B) of decreased lateral spacing between adjacent lands (as compared to the segments A). When processed through this roller configuration, the working surface of the resultant web had regions of high loft (akin to the first regions 30 of FIGS. 1-3) corresponding with the segments A, and regions of intermediate loft (akin to the second regions 32 of FIGS. 1-3) corresponding with the segments B. Direct contact with the lands resulted in regions of lower loft (akin to the third regions 34 of FIGS. 1-3). The formed web was glued to a 3.5 oz/yd² absorbent layer from Sage Products, Inc. (CS120-0825), and loaded with 600% by weight cleaning solution.

### Example 4

A lofty 50 gsm web comprised of a blend of 55% 25 denier T-295 PET fiber from KoSa, Charlotte, N.C., 15% 1.5 denier 8648 Rayon fiber from Lenzing, and 30% T-254 bi-component fiber from KoSa was blended and carded into a uniform web of loose fibers using a Hergeth carding machine. The carded web was then processed though an oven to melt the sheath of the bi-component fiber to bond the web together for future processing. Alternately, the carded web could be fed directly to the embossing rollers (described below), thus bypassing the oven process. The bonded web was then processed, along with a 3.5 oz/yd² cellulosic absorbent web from Sage Products Inc. (CS120-0825), through a calender system including a patterned embossing roller and a flat roller. With Example 4, the patterned roller was a three level embossing roller having the pattern of FIG. 7, with the pattern being applied to the web/backing in the machine direction. Both rolls were heated to about 295° F. to provide energy for forming and bonding. Also, pressure of 100 PLI was provided to the closed rollers. The 50 gsm blended web was fed along with the absorbent web into the embossing rollers where the lofty web was compressed and bonded to the absorbent web and formed to the final machine direction, three level geometry as described above. The formed web was loaded with 600% by weight cleaning solution.

### Example 5

A lofty 50 gsm web comprised of a blend of 55% 25 denier T-295 PET fiber from KoSa, 15% 1.5 denier 8648 Rayon fiber from Lenzing, and 30% T-254 bi-component fiber from KoSa was blended and carded into a uniform web of loose fibers using a Hergeth carding machine. The carded web was then processed though an oven to melt the sheath of the bi-component fiber to bond the web together for future processing. Alternately, the carded web could be fed directly to the embossing rollers (described below), thus bypassing the oven process. The bonded web was then processed, along with a 3.5 oz/yd² cellulosic absorbent web from Sage Products Inc. (CS120-0825), through a calender system including a patterned embossing roller and a flat roller. With Example 5, the patterned embossing roller was a three level embossing roller having the pattern of FIG. 8, with the pattern being applied to the web/backing in the machine direction. Both rollers were heated to about 295° F. to provide energy for forming and bonding. Also, pressure of 100 PLI was provided to the closed rollers. The 50 gsm blended web was fed along with the absorbent web into the embossing rollers where the lofty web was compressed and bonded to the absorbent web and formed to the final machine direction three level geometry as described above. The formed web was loaded with 600% by weight cleaning solution.

### Example 6

Same as Example 2, except the three level working regions were oriented parallel to the direction of use (e.g., perpendicular to the machine direction).

### Example 7

Same as Example 3, except the three level working regions were oriented parallel to the direction of use (e.g., perpendicular to the machine direction).

Test Methods

Hair, sand, and cotton linter pick up is measured by evenly distributing twenty hairs over a 40 ft² vinyl floor. 1.0 g sand (sieved 77 microns to 125 microns) and 0.1 g cotton linters are mixed together and also sprinkled over the floor. A wetted cleaning wipe sample is attached to a mop. Using the mop, the attached cleaning wipe sample is initially placed on the floor at one corner thereof, pushed toward an opposite side of the floor, turned 180°, and pulled back to the starting position. The mop is then manipulated to lift the attached cleaning wipe from the floor and then replaced on to the floor adjacent the previous line of travel. The wiping process is repeated until the entire 40 ft² floor has been wiped once with the cleaning wipe. The floor is allowed to dry. Once dry, a Scoth-Brite™ Super-Cling dry cloth (available from 3M Company) is first weighed (and recorded as initial weight), and then used to sweep/wipe the entire floor three times to pick up remaining debris. The Super-Cling dry cloth is again weighed, and the number recorded as a final weight.

The Percent Hair Pick-Up is determined by counting the number of hairs retained by the wetted cleaning wipe sample. This number is divided by 20 and multipled by 100, resulting in Percent Hair Pick Up.

Percent Sand/Cotton Pick-Up (or “Percent Sand Pick Up”) is determined by first subtracting the initial weight of the Super-Cling dry cloth from the final weight to obtain the weight of the sand/cotton that the cleaning wipe sample did not pick up. This value is subtracted from 1.1 gram to determine the weight of the sand/cotton that the cleaning wipe sample did pick up. The weight of the picked up sand/cotton is divided by 1.1 grams and multipled by 100, resulting in Percent Sand Pick Up.

Results

Three samples of each of Examples 1, 2, 3, 6, and 7 were each evaluated using the Test Methods described above. The Percent Hair Pick Up and Percent Sand Pick Up are given in Table 1. In addition, commercially available wetted cleaning wipes of Swiffer Wet™ (Procter & Gamble, Cincinnati, Ohio, product #95185478) and Scotch-Brite Wet Cloths (3M Company, #34-8509-1185-9) were similarly tested for purposes of comparison.

TABLE 1

| Sample | Percent Hair Pickup | Percent Sand Pickup |
|---|---|---|
| Swiffer Wet ™ Floor Cloth | 53.3% | 73.0% |
| Scotch-Brite ™ Wet | 73.3% | 79.4% |
| Floor Cloths | | |
| Example 2 | 83.3% | 87.0% |
| Example 3 | 93.3% | 89.4% |
| Example 1 | 41.7% | 79.1% |

Comparing Example 1 with Examples 2 and 3 in Table 1 illustrates how the addition of the first, high loft working region (Examples 2 and 3) significantly improves the hair pick up over the basis geometry with only two working regions (Example 1). Table 1 further illustrates the performance advantage over commercially available wetted cleaning wipe products which also only have two working regions. Sand/cotton pick up is also improved by the addition of the first lofty region (Examples 2 and 3) to the basis geometry (Example 1).

Table 2 reflects a comparison of the test results for Examples 2 and 3 versus Examples 6 and 7. In particular, Table 2 illustrates how the orientation of the working surface regions relative to the direction of use or wiping direction affect hair pick up. The working surface regions of Examples 2 and 3 were oriented perpendicular to the direction of use or wiping, whereas the working surface regions of Examples 6 and 7 were oriented parallel to the direction of use or wiping. The parallel orientation negatively affected hair pick up.

TABLE 2

| Sample | Percent Hair Pickup | Percent Sand Pickup |
|---|---|---|
| Example 2 | 83.3% | 87.0% |
| Example 3 | 93.3% | 89.4% |
| Example 6 | 55.0% | 84.5 |
| Example 7 | 81.7% | 86.1% |

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A cleaning wipe useful as a wet wipe for picking up diverse debris, such as hair, the cleaning wipe comprising:
a web defining a working surface opposite a second surface, the working surface defining at least a first region having a first degree of loftiness and a first height, a second region having a second degree of loftiness and a second height, and a third region having a third degree of loftiness and a third height, wherein:
first degree of loftiness>second degree of loftiness>third degree of loftiness, and
first height>second height>third height.

2. The cleaning wipe of claim 1, wherein the web has a uniform construction, such that a material composition of the first, second, and third regions is identical.

3. The cleaning wipe of claim 1, wherein the working surface includes a plurality of the first regions, a plurality of the second regions, and a plurality of the third regions, and further wherein an adjacent pair of first regions are separated by at least one of the second regions and at least one of the third regions.

4. The cleaning wipe of claim 3, wherein the adjacent pair of first regions are separated by a multiplicity of the second regions, adjacent ones of which are separated by one of the third regions.

5. The cleaning wipe of claim 4, wherein a lateral distance between the adjacent pair of first regions is not less than a width of either of the pair of first regions.

6. The cleaning wipe of claim 3, wherein the plurality of first, second, and third regions combine to define a pattern across the working surface, the pattern including adjacent pairs of first regions separated by a multiplicity of second regions, the multiplicity of second regions otherwise formed between each of the adjacent pair of first regions being separated by one of the third regions.

7. The cleaning wipe of claim 6, wherein each of the regions has a length greater than a width, and further wherein a width of the first regions is greater than the width of the second regions and the third regions.

8. The cleaning wipe of claim 7, wherein at least one of the first regions, at least one of the second regions, and at least one of the third regions extends across at least 75% of a corresponding dimension of the working surface.

9. The cleaning wipe of claim 1, wherein the first region is adapted to retain a first debris and the second region is adapted to retain a second debris, the first debris being generally finer than the second debris.

10. The cleaning wipe of claim 1, wherein the first degree of loftiness is characterized as having a bulk density of at least 100% less than a bulk density associated with the second degree of loftiness.

11. The cleaning wipe of claim 1, wherein the web is a non-woven substrate, such that the working surface consists of non-woven fibers, and further wherein the first region is characterized as having less fibers per unit volume than the second region and the third region.

12. The cleaning wipe of claim 11, wherein the second region is characterized as having less fibers per unit volume than the third region.

13. The cleaning wipe of claim 1, wherein the working surface includes at least partially looped fibers.

14. The cleaning wipe of claim 1, wherein the web defining the working surface is a first web, the cleaning wipe further comprising:
a second web connected to the second surface of the first web such that the second web defines a back surface of the cleaning wipe, the back surface being adapted for attachment to a tool.

15. The cleaning wipe of claim 14, further comprising a third web disposed between the first and second webs, the third web configured to retain liquid.

16. A package of cleaning wipes for picking up diverse debris, such as hair, the package comprising:
a plurality of stacked cleaning wipes each including a working surface having at least a first region, a second region, and a third region, wherein a degree of loftiness of the first region is greater than that of the second region, and a degree of loftiness of the second region is greater than that of the third region;
a liquid wetting each of the wipes; and
a container containing the wipes and liquid.

17. A method of cleaning hair and particulate debris from a surface, the method comprising:
providing a wet cleaning wipe including a web defining a working surface having at least a first region, a second region, and a third region, the first region having a degree of loftiness and height greater than that of the second region, and the second region having a degree of loftiness and height greater than that of the third region; and
guiding the wetted working surface of the wipe across the surface to be cleaned such that hair and particulate debris are retained by the cleaning wipe;
wherein the retained hair is primarily retained in the first region and the retained particulate debris is primarily retained in the second region.

18. The method of claim 17, wherein providing a wet cleaning wipe includes providing a cleaning wipe in dry form to a user followed by the user exposing the dry cleaning wipe to liquid.

19. The method of claim 17, further comprising:
securing the cleaning wipe to a tool such that guiding the working surface includes manipulating the tool.

20. The method of claim 17, wherein the working surface includes a multiplicity of first regions, adjacent ones of which are separated by a multiplicity of second regions, adjacent ones of which are separated by respective ones of the third regions, and the method further being characterized by at least 50% of hair initially present on the surface over which the working surface is guided being retained in the multiplicity of first regions and at least 50% of the particulate debris initially present on the surface over which the working surface is guided being retained in the multiplicity of second regions.

21. A cleaning wipe useful as a wet wipe for picking up diverse debris, such as hair, the cleaning wipe comprising:
a web defining a working surface opposite a second surface, the working surface having a uniform material construction and defining:
a plurality of laterally extending first regions,
a plurality of laterally extending second regions, and
a plurality of laterally extending third regions,
wherein the first, second, and third regions are arranged in a repeating pattern of adjacent first regions separated by second regions adjacent ones of which are separated by one of the third regions, wherein a width of each first region is greater than a width of each third region;
and further wherein a degree of loftiness and height of the first region is greater than that of the second region, and a degree of loftiness and height of the second region is greater than that of the third region.
